(19) United States
(12) Patent Application Publication
(10) Pub. No.: US 2015/0100401 A1
(43) Pub. Date: Apr. 9, 2015

(54) INCENTIVE-BASED HOME COMPOSTING SYSTEM AND METHOD THEREOF

(71) Applicant: The Procter & Gamble Company, Cincinnati, OH (US)

(72) Inventors: Jennifer Melissa Ross DEVINE, Cincinnati, OH (US); Russell Lance SPEILLER, Montgomery, OH (US)

(21) Appl. No.: 14/522,607

(22) Filed: Oct. 24, 2014

Related U.S. Application Data
(63) Continuation of application No. PCT/US2013/037960, filed on Apr. 24, 2013.
(60) Provisional application No. 61/638,507, filed on Apr. 26, 2012.
(60) Provisional application No. 61/644,532, filed on May 9, 2012.

(51) Int. Cl. G06Q 30/02

(52) U.S. Cl. CPC G06Q 30/0217
USPC 705/14.19

(57) ABSTRACT

An incentive-based home composting system encourages consumers to compost thereby reducing the amount of waste that is delivered to landfills.

### FIELD OF THE INVENTION

The present invention is directed to incentivizing consumers to use their home composting appliances thereby reducing the amount of waste that is deposited into landfills.

### BACKGROUND OF THE INVENTION

Incentive-based water reductions systems have generally been described. US 2009/0276299 A1; US 2006/0178933 A1; US 2008/0059970 A1. However, many of these systems are directed to recycling programs where trucks etc are used to pick up the recyclables.

However, there is a need to incentivize consumers to reduce compostable waste by the use of composting appliances. Home composting appliances are commercially available but have had little penetration. Thus, there is a need for an incentive-based system designed to encourage home composting, and a method of operating and managing the same.

### SUMMARY OF THE INVENTION

The present invention attempts to address one or more of these needs by providing, in aspect of the invention, an incentive-based home composting system. The system comprises a home composting appliance capable of receiving compostable material, wherein the appliance comprises a load-determining device, wherein the load-determining device is capable of obtaining a quantifiable measure of compostable material deposited from an entity into the home composting appliance. The system further comprises a value associated with the quantifiable measure of compostable material. A credit value associated with at least a quantifiable measure of deposited compostable material. An optional reward value is associated with the credit value. Preferably a reward associated with the reward value is provided to the consumer using the home composting system as a further incentive.

Another aspect of the invention provides for a method of providing an incentive to a consumer comprising the step of providing a composting appliance that comprises a load-determining device. Another aspect of the invention provides for a composting appliance that comprises a load determining device.

### BRIEF DESCRIPTION OF THE DRAWINGS

FIG. 1 depicts an incentive-based home composting system in accordance with one embodiment of the invention.

FIG. 2 depicts a general purpose computing system in accordance with one embodiment of the present invention.

### DETAILED DESCRIPTION OF THE INVENTION

A first aspect of the invention provides a composting appliance (preferably for in-home use), in the simplest sense, comprises a reacting container or designated area suitable for containing food scraps and other suitable materials for composting. The reacting container is typically from about 1 liter to about 100 liters, alternatively from 25 liters to 75 liters, alternatively from 35 liters to 65 liters, alternatively combinations thereof. The appliance may contain a lid or other similar means of enclosing/accessing the reacting container (and the contents contained therein). The lid mitigates the emission of malodor emitting from materials contained in the reacting container. The home composting appliance typically comprising a mixing means that will mix the contents of the reacting container to facilitate the composting processes (e.g., improve air flow). The mixing means may be engaged on a periodic basis or a continuous basis or a combination thereof. The appliance may optionally contain a heater means (e.g., electrical heating jacket) to heat the reacting container and/or the contents contained in the container to facilitate the composting processes since many composting microbes prefer temperatures above those of ambient (i.e., above about 21° C.). Preferably the reacting container is insulated so that heating is more efficient/economical. The lid may serve the function of preventing the contents of the container from being splattered out during the mixing process and/or keeping heat contained in the container/contents (should a heater be used). In some composting appliances, there is a curing container. In other words, some appliances have a two stage process—an initial active phase and a subsequent curing phase. The curing phase is typically longer in time than the active phase. The curing container may have the volumetric parameters as previously described for the reacting container. Non-limiting examples of composting appliances include those described in JP 3601973 B2; and US 2008/0209967 A1. In one embodiment, the articles of the present invention are administered to a composting appliance, alternatively specifically to an active container of an in-home composting appliance. In another embodiment, the articles are administered to a curing container of an in-home composting appliance. In yet other embodiments, the articles are administered to both the active container and the curing container of the in-home composting appliance. In one embodiment, in-home composting is conducted in a bin, bucket or bag, alternatively without mechanical mixing and/or without external heating. In yet another embodiment, the contents of the appliance either pre- or post-composting may be a contained in a bag, preferably a biodegradable bag. The volume of the bag may be similar to the volume previously expressed for the reacting container.

One aspect of the invention provides for a composting appliance comprising a dispenser that is in fluid communication with the reacting container and/or curing container (or additional containers the appliance may have). The dispenser further comprises a dispensing container that is capable of containing one or more compositions of the present invention, and preferably dispensing portions of the composition to the container of the composting appliance. In one embodiment, the volume of the dispensing container is from about 10 ml to about 4,000 ml (or more), alternatively about 100 ml to about 2,000 ml, alternatively from about 500 ml to about 1,000 ml, alternatively combinations thereof. Alternatively, the dispenser is capable of containing a plurality of unit doses, alternatively a plurality of unit dose articles, of the present invention, and preferably dispensing these unit doses or unit dose articles to the container of the composting appliance. The dispensing of the composition/unit dose/article by the dispenser is actuated by one or more events. The event may be the user opening the lid or pressing a button on the appliance or a pre-determined time interval (e.g., daily) or a sensor detecting a stimulus (e.g., malodor, the weight of pre-compost being added to the reacting container, etc).

The appliance may contain more than one dispenser. There may be a first dispenser dedicated to the reacting container, and a second dispenser dedicated to the curing container. Alternatively, there may be a first dispenser dedicated to dispensing a first composition to the reacting container and a second dispenser dedicated to dispensing a second composition also to the reacting container. A third and fourth dispenser may be dedicated to dispensing a respective third and fourth composition to the curing container. Combinations of these dispensers are also contemplated.

In one embodiment, the compostable material comprises food scraps (e.g., spoiled or uneaten food). In another embodiment, compostable material is free or substantially free of recyclable materials (such as glass and aluminum).

In one aspect of the invention the composting appliance contains a load-determining device and a data acquisition unit. The load-determining device may include any of, any multiple of, any combination of or any combination of multiples of a scale, load cell, load-cell system, a counting device and/or system or other measuring apparatus or system for (i) determining a quantifiable measure (e.g., weight, quantity, etc.) of the deposited material and/or (ii) transferring such quantifiable measure (“deposited-material measure”) to the data-acquisition unit for storage and/or subsequent processing. The data- acquisition unit may be in communication with a host. The data-acquisition unit may communicate the deposited-material measure to the host.

In one embodiment, the quantifiable measure is measured at the end of a composting cycle. Without wishing to be bound by theory, cycling will allow more “standardized” of the quantifiable. Such measurements taken before the initiation of the composting process by the appliance may provide an inaccurate measurement unduly influenced by the water content (or lack thereof) that may otherwise results when compostable material is first deposited into the composting appliance. In yet another embodiment, the quantifiable measure is measured at the conclusion of the composting process per the composting appliance.

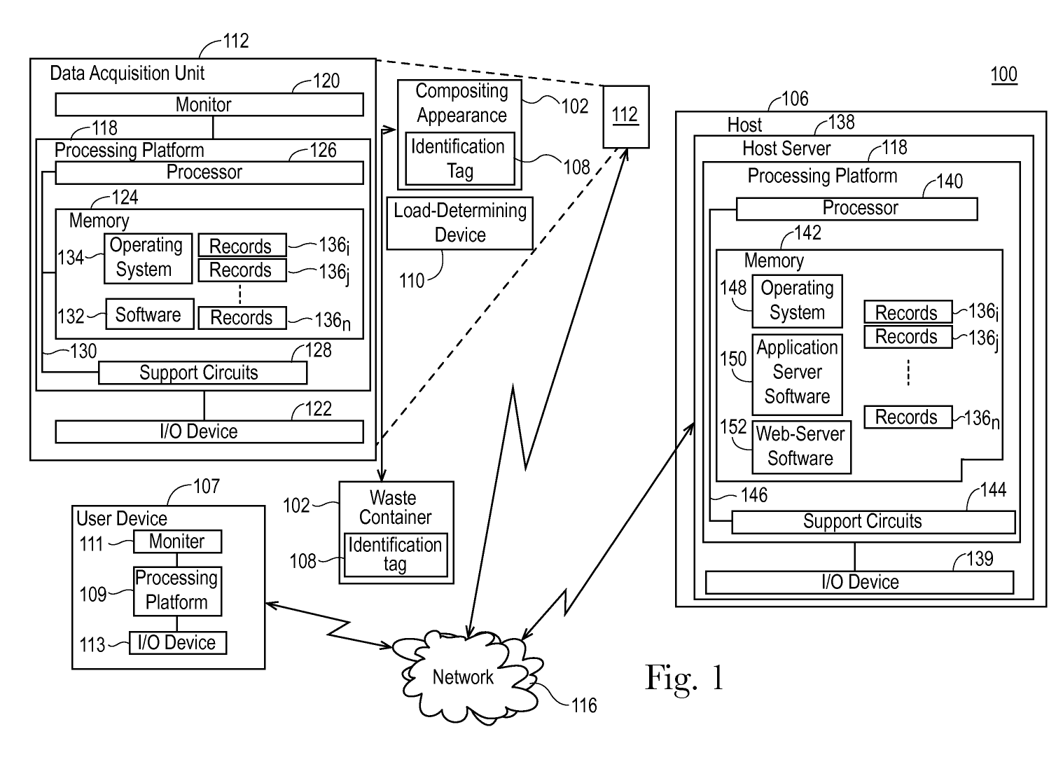

FIG. 1 depicts an incentive-based home composting system in accordance with one embodiment of the present invention. Generally, the system 100 comprises a composting appliance 102, a host 106 and a user device 107.

In many embodiments, the composting appliance 102 is adapted to accept compostable material deposited by an entity (“deposited material”) for composting.

The composting appliance 102 may be of any shape or size so long as it is adapted to hold a quantifiable measure of the deposited material. Non-limiting examples of composting appliances include US 2009/145188 A1.

The composting appliance 102 may include an identification tag 108 for identifying the composting appliance 102, preferably identify the composting appliance 102 to an entity. The identification tag 108 may be machine-readable device, such as a bar-code label, a magnetic-strip device, a radio-frequency-identification (“RFID”) tag and the like; and may include and/or be programmed with information for identifying the composting appliance 102, and in turn, information (e.g., an address, an account, etc.) associated with the entity (“entity information”).

Alternatively, the identification tag 108 may be a non-machine readable label or other non-machine readable device. As such, the identification tag 108 may include an identifier that can be transferred to (e.g., manually entered into) the host 106, which in turn, uses the identifier to obtain information stored thereon for identifying the composting appliance 102 and the entity information.

The composting appliance 102 may include a load-determining device 110 and a data acquisition unit 112. The load-determining device 110 may include any of, any multiple of, any combination of or any combination of multiples of a scale, load cell, load-cell system, a counting device and/or system or other measuring apparatus or system for (i) determining a quantifiable measure (e.g., weight, quantity, etc.) of the deposited material and/or (ii) transferring such quantifiable measure (“deposited-material measure”) to the data-acquisition unit 112 for storage and/or subsequent processing.

Some or the entire load-determining device 110 may be coupled (e.g., affixed or removably attached) to the composting appliance 102.

The data-acquisition unit 112 and host 106 may be communicatively coupled together via a link or network (collectively “network”) 116. This way, the data-acquisition unit 112 and host 106 may exchange information via one or more communications carried over the network 116.

Some or the entire data- acquisition unit 112 may be coupled (e.g., affixed or removable attached) to the composting appliance 102.

The network 116 may be a partial or full deployment of most any communication or computer network or link, including any of, any multiple of, any combination of or any combination of multiples of a public or private, terrestrial wireless or satellite, and wireline networks or links. Further details of the network as described in ¶31 of US 2009/0276299 A1.

The network elements and/or communication links may include circuit switches as well as packet-data elements to provide transport of content, triggers and/or other information; and may be configured to communicate such information using any number of protocols and in any manner consistent with exchanging such information among data-acquisition unit 112 and host 106. These protocols may include standardized, proprietary, open-source, and freely-available communication protocols for communicating content in circuit-switching and/or packet data networks, and the like.

The data acquisition unit 112 may be, for example, any of or any combination of a personal computer; a portable computer, a handheld computer, a mobile phone, a digital assistant, a personal digital assistant, a cellular phone, a smart phone, a pager, a digital tablet, a laptop computer, an Internet appliance and the like. In general, the data acquisition unit 112 includes a processor-based platform that operates on any suitable operating system; and that is capable of executing software.

Additionally, the data acquisition unit 112 may be formed in a single unitary device and concentrated on a single server, client, peer or other type node. Alternatively, the data acquisition unit 112 may be formed from one or more separate devices, and as such, may be distributed among a number of server, client, peer or other type nodes. The data acquisition unit 112 may also be scalable (i.e., may employ scale-up and/or scale-out approaches).

The data acquisition unit 112 may include a large number of elements, most of which are not shown in FIG. 1 for simplicity of exposition. As shown, the data acquisition unit 112 includes a processing platform 118 that is operable to control, manipulate or otherwise interact with a monitor 120 or other display device (collectively “monitor”) and/or an input/output (“I/O”) device 122, via respective couplings.

The monitor 120 may be any suitable device that displays viewable images and/or text generated by the processing platform 118. Further details of the monitor are described at ¶36 of US 2009/0276299 A1.

The I/O device 122 may be any device that accepts input from a user (man or machine) to control, manipulate or otherwise interact with the operation of the processing platform 118. In addition, the I/O device 122 may be adapted to obtain from the identification tag 108 the entity information and/or identifier that identifies the composting appliance 102. Examples of the I/O device 120 are described at ¶37 of US 2009/0276299 A1.

The processing platform 118 includes memory 124, one or more processors (collectively “processor”) 126, support circuits 128 and bus 130. Examples of memory are described in at ¶36, ¶71 of US 2009/0276299 A1.

The memory 124 may store and/or receive requests from the processor 126 to execute software 132, such as operating system 134. Additionally, the memory 124 may store and/or receive requests from the processor 126 to obtain (i) operands, operators, dimensional values, configurations, and other data that are used by the operating system 134 and the software 132 to control the operation of and/or to facilitate performing the functions of the data acquisition unit 112; and/or (ii) one or more records or other data structures (collectively, “records”) 136ᵢ-136ₙ.

Each of the records 136ᵢ-136ₙ may be stored as or in a single file or a plurality of files, and may be structured as text, a table, a database, a distributed hash table, a distributed concurrent object store, a document formed using a markup or markup-like language, any other structure feasible in the context of the present invention, any combination thereof, or the like. The records 136ᵢ-136ₙ may include, for example, a deposited-material record 136j. The deposited-material record 136j may store, be populated with, or otherwise adapted to hold the deposited-material measure as determined by the load-determining device 110.

The processor 126 may execute (e.g., launch, generate, run, maintain, etc.) and/or operate on the operating system 134. The processor 126 may be capable of (i) executing the software 132; (ii) storing the records 136ᵢ-136ₙ in the memory 124; (iii) dispatching to the host 106 the records 136ᵢ-136ₙ (including the deposited-material record 136ⱼ) for further processing; (iv) issuing triggers and/or (v) issuing one or more commands and/or instructions to cause the further processing of records 136ᵢ-136ₙ. Examples of the processor 126 include conventional processors, microprocessors, multi-core processors, microcontrollers, and the like.

The support circuits 128 facilitate operation of the processor 126 and may include well-known circuitry or circuits, including, for example, an I/O interface, one or more network-interface units (“NIUs”); cache; clock circuits; power supplies; any other structure feasible in the context of the present invention; any combination thereof; or the like. The NIUs may be adapted for communicating over any of, any multiple of, any combination of or any combination of multiples of terrestrial wireless, satellite, and/or wireline media. The processor 126 (and in turn, the data-acquisition unit 112) may use the NIUs for exchanging content with the host 106 via network 116.

The bus 130 provides for transmissions of digital information among the processor 126, the memory 124, support circuits 128 and other portions of the data acquisition unit 112 (shown and not shown). The I/O interface is adapted to control transmissions of digital information between (shown and not shown) components of the data acquisition unit 112. In addition, the I/O interface is adapted to control transmissions of digital information between I/O devices disposed within, associated with or otherwise attached to the data acquisition unit 112. Examples of the I/O devices are described at ¶43 of US 2009/0276299 A1.

The operating system 134 may include code for operating the data acquisition unit 112 and for providing a platform onto which the software 132 can be executed. The software 132 may include data-acquisition software, which may carry out the acquisition of and storage of the deposited-material measure into the deposited-material record 136j. The data-acquisition software may also communicate the deposited-material record 136j to the host 106 using, for example, the communication and/or security protocols compatible with the data acquisition unit 112 and the host 106. To facilitate this, the data-acquisition software may include code to allow the data-acquisition software (and/or the data acquisition unit 112) to substantiate its identity, and in turn, receive authorization to access (e.g., view, configure, use, and/or execute) services of the host 106.

The host 106 may include one or more servers, including a host server 138. The host server 138 may be deployed in one or more general or specialty purpose computers, personal computers, mainframes, minicomputers, server-type computers and/or any a processor-based platform that operates on any suitable operating system.

Like the data acquisition unit 112, the host server 138 may include a large number of elements, most of which are not shown in FIG. 1 for simplicity of exposition. The elements of host server 138 may be formed in a single unitary device and concentrated on a single server, client, peer or other type node. Alternatively, the elements of the host server 138 may be formed from two or more separate devices, and as such, may be distributed among a number of server, client, peer or other type nodes.

The host server 138 may be deployed in accordance with the scale-up and/or scale-out approaches. Using the scale-up approach, the host server 138 may increase its processing power, amount of memory and number of networkable connections by utilizing a symmetrical, multi-processor architecture so as to provide additional capacity. A benefit of this scale-up approach is that such approach provides for simplified configuration and management as compared to the scale-out approach. Using the scale-out approach, the host server 138 may increase its processing power, amount of memory and number of networkable connections by incrementally adding and/or removing capacity as needed, balancing workload across multiple processors, multiple servers, dedicating specific processors and/or servers for performing specific tasks, using physical or logical servers (e.g., a multi-node cluster approach), etc.

The host server 138 includes one or more processing units (collectively “processor”) 140, memory 142, support circuits 144 and bus 146. The processor 140 may be one or more conventional processors, microprocessors, multi-core processors, microcontrollers, any other processor type feasible in the context of the present invention, any combination thereof, or the like.

The bus 146 provides for transmissions of digital information among the processor 140, memory 142 and support circuits 144 and other (not shown) portions of the host server 138. The support circuits 144 facilitate operation of the processor 140, and may include well-known circuitry or circuits, including, for example, one or more input/output I/O interfaces, one or more NIUs, cache, clock circuits, power supplies, and the like.

The I/O interface provides an interface to control the transmissions of digital information among (shown and not shown) components of host server 138. In addition, the I/O interface provides an interface to control the transmissions of digital information among I/O devices 139 associated with or otherwise attached to the host server 138. The I/O devices 139 may be embodied as any or any combination of (i) storage devices, including but not limited to, a tape drive, a floppy drive, a hard disk drive or a compact disk drive; (ii) a receiver; (ii) a transmitter; (iii) a speaker; (iv) a display; (v) a speech synthesizer; (vi) an output port; (vii) a pointing device, such as a mouse, joystick, trackball, touchpad, pointing stick, light pen, head pointer, soap mouse, eye tracking devices, digitizing tablet and stylus, data glove that translates the user's movements to computer gestures; (vii) a key-in device, such as a keyboard or a touchpad; (viii) and the like.

The NIUs facilitate exchange (e.g., sending and/or receiving) of content. Accordingly, the NIUs may be adapted for communicating over terrestrial wireless, satellite, and/or wireline media.

The memory 124 may store and/or receive requests from the processor 140 to execute various software packages, such as operating system 148, application-server software 150 and web-server software 152. Examples of memory are described at ¶¶38, 52, and 71 of US 2009/0276299 A.

Additionally, the memory 142 may store and/or receive requests from the processor 140 to obtain the records 136ᵢ-136ₙ (e.g., copies thereof). As above, each of the records 136ᵢ-136ₙ may be stored as or in a single file or a plurality of files, and may be structured as text, a table, a database, a distributed hash table, a distributed concurrent object store, a document formed using a markup or markup-like language, or the like, or any combination thereof. The records 136ᵢ-136ₙ may be stored, for example, using a Microsoft SQL Server and accessible through an ODBC connection.

Like the records 136ᵢ-136ₙ, the memory 142 may store and/or receive requests from the processor 140 to obtain operands, operators, dimensional values, configurations, and other data that are used by the various software packages to control the operation of and/or to facilitate performing the functions of the host server 138 and/or the host 106.

The application-server software 150, when executed by the processor 140, is operable to (i) communicate with the data acquisition unit 112, via the network 116, to obtain the deposited-material record 136j; and determine a value associated with the deposited-material measure stored in the deposited-material record 136j. In addition, the application-server software 150, when executed by the processor 140, is operable to associate the value to a credit, which may be redeemable by the entity; post the credit to a user account associated with the entity (“entity account”); and provide the web-server software 152 with access to the entity account.

The web-server software 152, when executed by the processor 140, is operable to provide one or more web pages to allow the entity to access the entity account, and in turn, the credit and other information associated with the home composting activities. For example, web-server software 152 may post the credit on the web pages that are accessible to entity via the user device 107 and entity account, so as to enable the entity to view details of the entity account. The details of the entity account may include the credit (and/or previously accrued credits) associated with the home composting activities of the deposited (and/or previously deposited) material, dates associated with the home composting activities, quantities and types of the deposited (and/or previously deposited) material recycled over a given period of time, debits from the credit (and/or previously accrued credits), detailed history of spending of the credit (and/or previously accrued credits), any orders or vouchers for redeemed credits, any other data or information feasible in the context of the present invention, any combination thereof, or the like.

In addition, the web-server software 152, when executed by the processor 140, is operable to allow the entity, via the user device 107, to redeem the credit. This may include the web-server software 152 providing a portal to retailers to allow the entity to redeem the credit (and/or previously accrued credits) at the retailers to obtain goods, services, coupons valued for goods or services, other benefits or discounts, any other goods and/or services feasible in the context of the present invention, any combination thereof, or the like.

The web-server software 152 may also be operable to allow the entity to transform the credit (and/or previously accrued credits) into one or more vouchers that may be spent at the participating retailers or donated to some other entity. To facilitate this, the web-server software 152 includes code to allow the entity to (i) order the vouchers for delivery by mail, e-mail or other communication medium; and/or (ii) provide information to the entity via the user device 107 to allow the entity to print or otherwise reduce to physical form, store it on the user device 107 or a peripheral device coupled to the user device 107 (e.g., a PDA, memory device, etc.).

The user device 107 may be, for example, any of or any combination of a personal computer, a portable computer, a handheld computer, a mobile phone, a digital assistant, a personal digital assistant, a cellular phone, a smart phone, a pager, a digital tablet, a laptop computer, an Internet appliance and the like. In general, the user device 100 may include a processor-based platform that operates on any suitable operating system, such as Microsoft® Windows®, Linux and/or Symbian, that is capable of executing software.

The user device 107 may, however, include a large number of elements, many of which are not shown in FIG. 1 for simplicity of exposition. The user device 107 includes elements similar to the data acquisition unit 112, except as described herein below. The user device 107 may be formed in a single unitary device and concentrated on a single server, client, peer or other type node. Alternatively, the user device 107 may be formed from one or more separate devices, and as such, may be distributed among a number of server, client, peer or other type nodes. In addition, the user device 107 may be scalable.

As shown, the user device 107 may include a processing platform 109 operable to control, manipulate or otherwise interact with a monitor 111 and/or an I/O device 113, via respective couplings. The processing platform 109, the monitor 111 and the I/O device 113 include elements similar to or the same as the processing platform 118, the monitor 120 and the I/O device 122 of the data acquisition unit 112, and as such, the details of such elements are not reproduced here for simplicity of exposition.

The user device 107 is operable to form a user interface through which the entity can access the web pages provided by the web-server software 152. To facilitate this, the user interface may be communicatively coupled with the host server 138 via a network 116. The user interface may be, for example, a graphical-user interface that is operable to execute a web browser application for rendering on the monitor 111 the web pages provided by the web-server software 152. As noted, the entity may use the user device 107 to access the entity's account, redeem credits and/or other like functions.

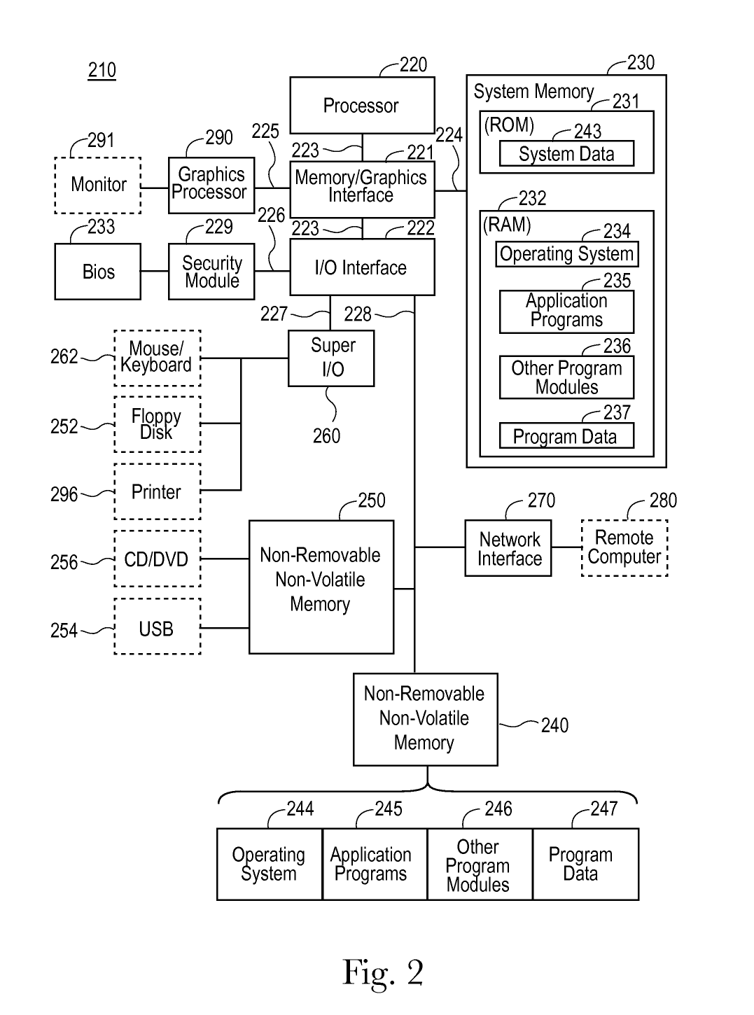

In accordance with one embodiment of the present invention, at least one of the data acquisition unit, the user device, and/or the host comprise a computer or computer device, for example, the general purpose computing device in the form of a computer 210 depicted in FIG. 2. Components shown in dashed outline are not part of the computer 210. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes those described at ¶65, US 2009/0276299 A1. Communication media typically embodies computer readable instructions, data structures, program modules or other data in a modulated data signal such as a carrier wave or other transport mechanism and includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

As noted above, the value associated with the deposited-material measure may be financial (e.g., monetary or economic). For example, the value may be based, at least in part, on an amount of the deposited material. Alternatively, the value may be based, at least in part, upon financial offerings of one of more retailers participating in a rewards program (“participating retailers”). The value may have a minimum and/or a maximum. The maximum may be based on time (e.g., no more than “x” for a given period of time).

In accordance with one embodiment of the present invention, an entity may be allotted an allowable amount of disposable material—that is, all types of disposable material, including recyclables, organics, and garbage—over a specified period of time (e.g., a week, two weeks, a month). This allotment may also be determined by the size of the entity and how many waste generating units for which that entity may be accountable. During such time, if the entity produces exactly the allotted amount of disposable material, the entity is assigned a predetermined value associated with the deposited-material measure. If the entity produces less than the allotted amount of disposable material, the entity is assigned a value associated with the deposited-material measure that is more desirable than the value that would have been assigned to the entity if the entity had produced exactly the allotted amount of disposable material.

Conversely, if the entity produces more than the allotted amount of disposable material, the entity is assigned a value associated with the deposited-material measure that is less desirable than the value that would have been assigned to the entity if the entity had produced exactly the allotted amount of disposable material. In some embodiments, an entity may be debited a value correlating to the undesirable amount of disposable material, or a set amount. In such types of embodiments, not only is an incentive present to motivate an entity to compost, reuse and recycle, but a penalty is present in the event the entity does not adequately perform to the incentivized levels.

In accordance with another embodiment of the present invention, the value assigned to an entity associated with the deposited-material measure may be additionally affected by a ratio.

Such a ratio may compare a measure of non-reusable material (i.e., garbage) with a measure of reusable material (e.g., recyclable material, organics, compostable material). The ratio may be a ratio of compostable material to recyclable material, a ratio of compostable material to a total amount of material (i.e., a sum of reusable and non-reusable material), a ratio of reusable material to a total amount of material or any other ratio or comparison feasible in the context of the present invention. Ratios may also be selective based on a particular type of compostable material or reusable material. For example, a ratio may be between types of organics in the reusable materials. Any of these ratios may be referred to herein as a “diversion ratio.”

In one such embodiment, the value may be adversely affected if the ratio of compostable material to reusable material is above a specified value. Conversely, the value may be positively affected if the ratio of compostable material to reusable material is below a specified value. Such a ratio may use any base that is feasible in the context of the present invention, including but not limited to weight, mass, volume, and quantity (e.g., articles, countable pieces).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An incentive-based home composting system comprising:
a home composting appliance capable of receiving compostable material, wherein the appliance comprises a load-determining device, wherein the load-determining device is configured to obtain a quantifiable measure of compostable material deposited from an entity into the home composting appliance;
a value associated with the quantifiable measure of compostable material.
an optional adjustment factor for adjusting the value associated with the quantifiable measure of compostable material, determined from an algorithm, the algorithm taking as an input at least a predetermined factor;
a credit value associated with at least a quantifiable measure of deposited compostable material; and
an optional reward value associated with the credit value.

2. The system of claim 1, further comprising the adjustment factor for adjusting the value associated with the quantifiable measure of compostable material and the value associated, determined from an algorithm, the algorithm taking as an input at least a predetermined factor.

3. The system of claim 2, further comprising the reward value associated with the credit value.

4. The incentive-based home composting system of claim 3, wherein the adjustment factor comprises at least one of a disposal allotment value or a diversion ratio.

5. The incentive-based home composting system of claim 4, wherein the adjustment factor increases the desirability of one or more values when a quantifiable measure of deposited material is more desirable as compared to the adjustment factor and decreases the desirability of one or more values when a quantifiable measure of deposited material is less desirable as compared to the adjustment factor.

6. The system of claim 5, wherein the compostable material comprises food scraps.

7. The system of claim 6, wherein the quantifiable measure of the compostable material is obtained at the end of a composting cycle of the home composting appliance.

8. The system of claim 7, wherein the compostable material is substantially free of recycle materials.

9. The system of claim 8, wherein the home composting appliance further comprises a container configured to contain the compostable material, and a mixing element configured to mix the compostable materials contained in the container.

10. The system of claim 9, wherein the home composting appliance further comprises a heater configured to heat the container.

11. The system of claim 10, wherein the home composting appliance comprises a first container and a second container each configured to contain compostable material, and wherein the load-determining device is configured to obtain a quantifiable measure of compostable material from the first container and the second container.

12. The system of claim 11, wherein the home composting appliance further comprises a first mixing element configured to mix the compostable materials in the first container and a second mixing element configured to mix the compostable materials in the second container.

13. The system of claim 12, wherein the recycle materials comprises glass and metal.

14. A method of providing an incentive to a consumer comprising the step of providing a home composting appliance capable of receiving compo stable material, wherein the appliance comprises a load-determining device, wherein the load-determining device is configured to obtain a quantifiable measure of compostable material deposited from an entity into the home composting appliance.

15. The method of claim 14, wherein the the home composting appliance further comprises a container configured to contain the compostable material, a mixing element configured to mix the compostable materials contained in the container, and a heater configured to heat the container.

16. The method of claim 15, wherein the load-determining device is a scale.

17. A composting appliance comprising: a home composting appliance capable of receiving compostable material, wherein the appliance comprises a load-determining device, wherein the load-determining device is configured to obtain a quantifiable measure of compostable material deposited from a consumer into the home composting appliance.

18. The appliance of claim 17, wherein the home composting appliance further comprises a container configured to contain the compostable material, a mixing element configured to mix the compostable materials contained in the container, and a heater configured to heat the container.

19. The appliance of claim 18, wherein the load-determining device is a scale.
